(19) United States
(12) Patent Application Publication
(10) Pub. No.: US 2021/0016641 A1
(43) Pub. Date: Jan. 21, 2021

(54) METHOD AND APPARATUS FOR TRANSPORTING VEHICLES

(71) Applicant: ANYTHING OK PTY. LTD, Carrum Downs, Victoria (AU)

(72) Inventor: Shaun Martindale, Carrum Downs, Victoria (AU)

(73) Assignee: Anything OK Pty. Ltd., Carrum Downs, Victoria (AU)

(21) Appl. No.: 17/040,424

(22) PCT Filed: Mar. 25, 2019
(86) PCT No.: PCT/AU2019/000033

§ 371 Date: Sep. 22, 2020

(30) Foreign Application Priority Data
Mar. 23, 2018 (AU) 2018900981

(51) Int. Cl. B60J 5/14; B65D 85/68; B60J 7/06; B60P 3/07

(52) U.S. Cl. CPC B60J 5/14; B65D 85/68; B65D 2585/6867; B60P 3/07; B60J 7/061

(57) ABSTRACT

The present invention an apparatus for transporting vehicles, in the form of a self-contained pod module, comprising a structural base having a low angle ramp, a structural front wall extending upwardly from a front end of the base having an inbuilt structural headboard frame, a retractable enclosure attachable to the base and the headboard frame to form the roof and side walls for the pod, said retractable enclosure being supported by at least one structural metal rib and a lockable roller door provided at a rear end of the pod module and attachable to the enclosure to provide a fully sealed enclosure.

### FIELD OF THE INVENTION

The present invention relates to the transportation of vehicles. In particular, but not exclusively, the present invention relates to a method and apparatus for transporting vehicles from one destination to another.

### BACKGROUND TO THE INVENTION

There are many options available for transporting vehicles from one destination to another. A tandem trailer can be utilised for self-transportation. A vehicle is loaded onto the trailer and the trailer is attached to another vehicle, which is then driven to transport the loaded vehicle. It is necessary to have a vehicle that can handle a heavy load.

Transportation companies offer a range of options including a standard multi-car carrier semi-trailer combination, tilt tray with retractable enclosure, enclosed truck bodies and shipping containers. The multi-car carriers are usually between 75 and 80 feet long with two levels for holding cars. They are less expensive than enclosed trailers, lighter and more fuel efficient resulting in less damage to the environment and offer better visibility for periodic inspection during transit. However, the transported vehicles are exposed to weather conditions and road debris with less overall security in comparison to enclosed trailers. Enclosed trailers have four walls and a roof to provide a housing for the vehicle(s) during transit. Enclosed trailers provide a better option for antique, luxury and sports vehicles due to the increased security and protection. The disadvantage being they are significantly more expensive and have less visibility for periodic inspections during transit. Shipping containers are used to transport vehicles internationally. The vehicle is loaded into the container where it is securely blocked, braced and tied down to ensure security during transit. The tilt tray is self-loading and suitable for carrying vehicles and containers to transport the vehicle from almost any site.

Each of the above methods are nearly identical in their process. The transported vehicle is driven, lifted or pulled into or onto another vehicle. At this point the transported vehicle is tied down to the vehicle or container using a standard industry strapping procedure. Most of the time the vehicles are handled multiple times during transit exposing the safety, protection and security of the vehicle.

In this specification, the terms “comprises”, “comprising” or similar terms are intended to mean a non-exclusive inclusion, such that a method and apparatus for transporting vehicles that comprises a list of elements does not include those elements solely, but may well include other elements not listed.

### OBJECT OF THE INVENTION

It is a preferred object of the present invention to provide a method and apparatus for transporting vehicles, that addresses or at least ameliorates one or more of the aforementioned problems of the prior art and/or provides consumers with a useful or commercial choice.

### SUMMARY OF THE INVENTION

Generally, embodiments of the present invention relate to a method and apparatus for transporting vehicles.

According to one aspect, although not necessarily the broadest aspect, the present invention resides in an apparatus for transporting vehicles, in the form of a self-contained pod module comprising:

a structural base having a low angle ramp;

a structural front wall extending upwardly from a front end of the base having an inbuilt structural headboard frame;

a retractable enclosure attachable to the base and the headboard frame to form the roof and side walls for the pod, said retractable enclosure being supported by at least one structural metal rib; and

a lockable roller door provided at a rear end of the pod module and attachable to the enclosure to provide a fully sealed enclosure.

Preferably, the retractable enclosure can be fully extended and locked to create a fully sealed unit around the transported vehicle.

Preferably, the retractable enclosure is made of a flexible canvas material.

Preferably, the retractable wall material is held in position by the least one structural metal rib which extends upwardly from the base and continuously along the retractable walls and is slidable along a sliding rail system provided on the base.

Preferably, the structural rib(s) are mounted to carriers for sliding along a rail of the sliding rail system via at least one upright mounting plate.

Preferably, at least one stop member, such as a rubber bump stop or the like, is provided at a rear end of the pod to stop the enclosure when sliding.

Preferably, at least a pair of forklift points are provided on at least one side of the base of the apparatus, allowing the pod to be safely lifted and moved using a forklift or crane on and off a transport vehicle.

Preferably, each corner point of the base has provided corner castings, allowing the pod to be connected to other pods or containers both horizontally and vertically, as well as being connected to various modes of transport such as ship, rail and road.

Preferably, an anti-slip floor surface is provided on a front floor portion and a rear floor portion of the base.

Preferably, at least one handle grip is provided at the rear end of the pod for pushing and pulling the retractable walls to open and close the enclosure.

Preferably, a centre section and/or remainder of the headboard frame is adapted to receive at least one strap member.

Preferably, the strap members, preferably aluminium straps, hold down and tension the retractable enclosure against the headboard frame.

Preferably, a weather strip is provided on the base beneath the roller door to ensure a tight, weatherproof seal for the enclosure.

Preferably, the roller door slides along the sliding rail system when the enclosure is retracted.

Preferably, the roller door is attached to the rearmost structural metal rib via rails or a frame or the like using a hinge which enables the roller door to open outwardly, allowing additional space for the transported vehicle.

Preferably, the headboard frame is designed to double as a toolbox or tyre rack, allowing for future toolboxes and/or storage units to be added.

Preferably, the apparatus for transporting vehicles may further comprise internal toolboxes and/or tyre/wheel holders may be provided.

Preferably, the apparatus further comprises at least one in-built remote access feature such as satellite tracking and/or live feed video camera for monitoring of the vehicle.

Preferably, a multi-platform application enables a client to connect to their vehicle's pod module and remote access features via a mobile device such as a phone, tablet or computer or the like.

According to another aspect, although again not necessarily the broadest aspect, the present invention resides in a method for transporting vehicles comprising the following steps:

opening a roller door of an apparatus of claim 1;

loading a vehicle to be transported into the apparatus; and

loading the apparatus containing the vehicle onto a mode of transport; and

wherein an enclosure of the apparatus can be retracted to allow the vehicle to be loaded/unloaded and allow an operator easy access to one or more sides of the transported vehicle at any time during transportation.

Further features and forms of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 shows a rear perspective view of an apparatus for transporting vehicles according to an embodiment of the present invention;

FIG. 2A shows a rear perspective view of the apparatus for transporting vehicles of FIG. 1 with a closed enclosure;

FIG. 2B shows a rear perspective view of the apparatus for transporting vehicles of FIG. 1 with an open roller door;

FIG. 2C shows a rear perspective view of the apparatus for transporting vehicles of FIG. 1 with an open enclosure and a vehicle being loaded; and

FIG. 2D shows a rear perspective view of the apparatus for transporting vehicles of FIG. 1 with an open enclosure and the vehicle loaded within the apparatus.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Embodiments of the present invention will be described with reference to a method and apparatus for transporting vehicles from one destination to another. The apparatus for transporting vehicle is in the form of a self-contained pod module. For convenience sake, the apparatus for transporting vehicles shall be referred to herein as a Carpod or pod. The Carpod is designed to act as a self-contained enclosed transport pod module that allows that operator the ability to load and unload vehicles or machinery onto another vehicle or piece of machinery safely and easily. It will be acknowledged that the materials, colour, size and dimensions of the Carpod may be varied as desired.

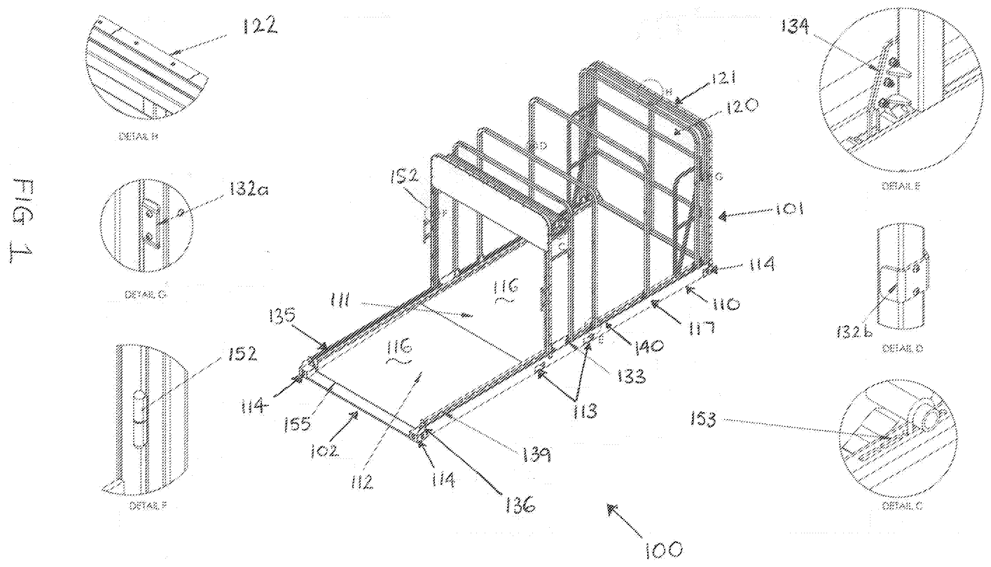

Referring to FIG. 1, the apparatus for transporting vehicles 100, in the form of a self-contained pod module which will be referred to hereinafter as a Carpod, comprises a structural metal base 110 with only one structural metal front wall 120. The base 110 has a base frame 117. The base 110 preferably comprises a front floor portion 111 which is substantially flat and a rear floor portion 112 which is angled rearwardly toward the ground in such a manner to create a low angle ramp. This enables a vehicle being transported, which will be referred to herein as the transported vehicle, to be loaded onto the Carpod at ground level, addressing many OH&S issues which are prevalent in current transportation systems. The transported vehicle is only loaded into the Carpod once the Carpod has been unloaded from the transport vehicle. This lowers the chance of damage to the front and rear of the vehicle being transported. Provided on at least one side of the base 110 of the Carpod is at least two forklift points 113, allowing the Carpod to be safely lifted and moved using a forklift or crane on and off a transport vehicle. The forklift points 113 are preferably in the form of pockets adapted to receive a forklift prong therein. Each of the four corner points of the base 110 have provided corner castings 114. The corner castings 114 are designed to enable the Carpod to be connected to other Carpods or containers via container pins, both horizontally and vertically, as well as being connected to modes of transport such as ship, rail and road. An anti-slip floor surface 116 is provided on the front and rear floor portions 111, 112 of the base 110. According to one embodiment, the anti-slip floor surface 116 is in the form of an adhesive sticker which is applied to the base 110. However, it is envisaged that any other suitable anti-slip surfacing may also be adopted for example, one which is applied via a spray means.

The front wall 120 extends upwardly from a front end 101 of the base 110 of the Carpod 100. The front wall 120 has an inbuilt structural headboard frame 121 which extends along the perimeter of the front wall 120. The headboard frame 121 is preferably designed to double as a toolbox or tyre rack, allowing for future toolboxes and/or storage units to be added. In a further embodiment, it is envisaged that internal toolboxes and/or tyre/wheel holders may be provided. A centre section 122 and/or remainder of the headboard frame 121 is adapted to receive at least one strap member (not shown). The strap members 134, preferably aluminium straps, hold down and tension the canvas material enclosure 130 against the headboard frame 121. It will be acknowledged that any other suitable securing/tensioning means can also be adopted.

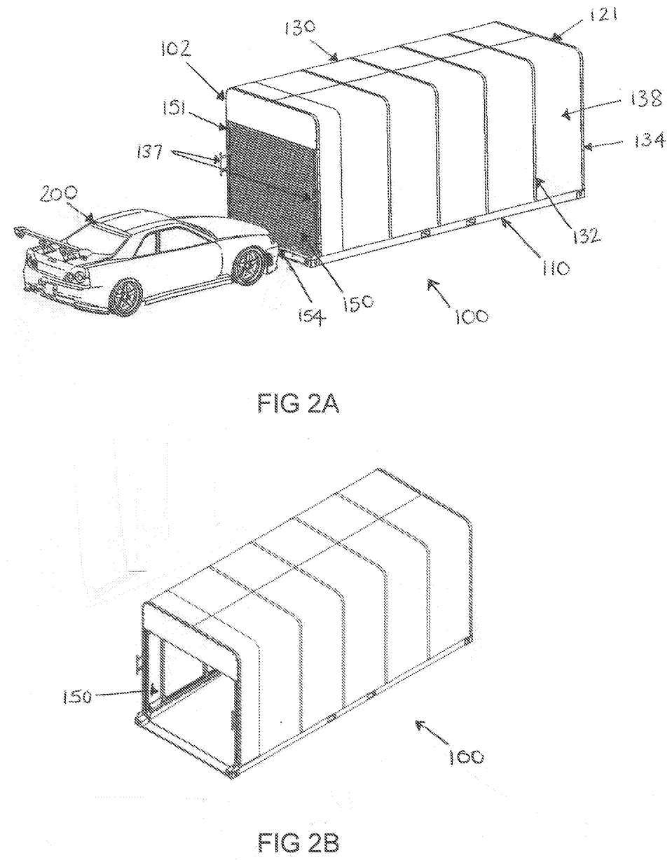

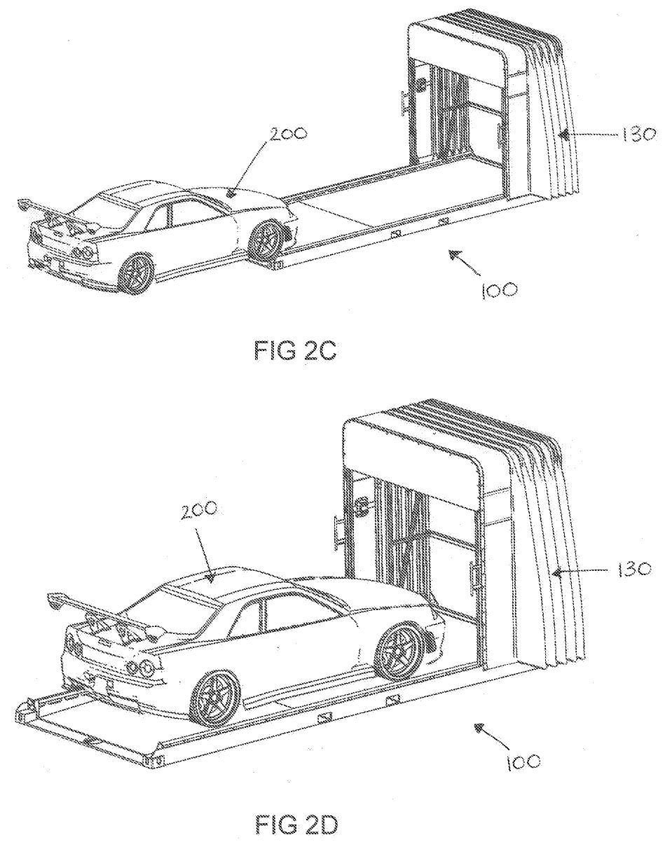

The Carpod 100 comprises an enclosure 130 made of a flexible canvas material which forms the roof and side walls for the Carpod 100, as shown in FIG. 2A. Referring to FIG. 2A, the roof and side wall material is held in position by at least one structural metal rib 132. The structural metal rib(s) 132 extend upwardly from the base 110 of the Carpod 100 and continuously along the perimeter of the retractable side and roof walls 138. The structural rib(s) 132 are substantially u-shaped to enable three walls to be formed. At least one handle grip 137 is provided at the rear end 102 of the Carpod for pushing and pulling the retractable walls 138 to open and close the enclosure 130.

Referring to FIGS. 1 and 2A, the structural rib(s) 132 are adapted to slide along a sliding rail system 140 attached to the base 110. The outermost structural ribs 132 are suitably provided with plastic guide end caps 132a, while the middle structural ribs 132 are suitably provided with plastic guide mid section caps 132b for the canvas material. The structural rib(s) 132 are mounted to carriers 133 via upright mounting plates 134. The carriers 133 run along a hardened steel rail 135, holding the rib(s) 132 in place and providing a smooth retractable system for the enclosure 130. While the present invention has been described as using carriers it is envisaged that any other suitable retractable system may also be adopted. The rope rail 139 inside allows for tie downs. At least one stop member 136, such as a rubber bump stop or the like, is provided at a rear end 102 of the Carpod 100 to stop the enclosure 130 when sliding. The retractable enclosure 130 allows an operator easy access to the sides of a transported vehicle 200 (shown in FIGS. 2A, 2C and 2D) within the Carpod 100.

Referring to FIGS. 1 and 2A, a roller door 150 is provided at the rear end 102 of the Carpod 100 to provide a fully sealed enclosure. A weather strip 155 is provided on the base 110 beneath the roller door 150 to ensure a tight, weatherproof seal for the enclosure 130. The roller door 150 may be similar to a standard garage roller door. The roller door 150 also slides along the sliding rail system 140 when the enclosure 130 is retracted. The roller door 150 is attached to the rearmost structural metal rib 132c via rails or a frame or the like 151 using a hinge 152 which enables the roller door 150 to open outwardly, allowing additional space for the transported vehicle. A plurality of slots 153 allow the garage door to be positioned and secured in place via a securing member 156 in an adjustable manner. The roller door 150 is lockable, comprising a centrally located locking mechanism 154 with a commercial padlock. However, it will be appreciated that any other suitable locking mechanism may also be adopted. For example, in a further embodiment, it is envisaged that the roller door may have provided a digital keypad lock.

In a further embodiment of the present invention, it is envisaged that the Carpod 100 may have provided at least one in-built remote access feature such as satellite tracking and/or live feed video camera. It is envisaged that a multi-platform application will be provided to enable clients to connect to their vehicle's Carpod via a mobile device such as a phone, tablet or computer or the like and access these features.

The present invention provides a method of transporting vehicles using the apparatus (Carpod) 100 described above. The transported vehicle 200 is loaded into the Carpod at ground level. Referring to FIG. 2B, the roller door 150 is unlocked and opened. Referring to FIGS. 2C and 2D, the enclosure 130 of the Carpod 100 can then be retracted to allow the transported vehicle 200 to be loaded/unloaded and allow an operator easy access to the sides of the transported vehicle 200. In a retracted position, the sliding mechanism is held in place using a suitable fixture such as a mechanical linkage, rope, chain or bolt or the like. Referring to FIG. 2A, the retractable enclosure 130 can be fully extended and locked to create a fully sealed unit around the transported vehicle. In an extended position, pressure can be applied to hold the sliding mechanism against the roller door frame using a suitable fixture such as a mechanical linkage, rope, chain or bolt or the like.

Hence, the method and apparatus for transporting vehicle provides a solution to the aforementioned problems of the prior art by providing an enclosed transport pod module that allows the operator the ability to load and unload vehicles or machinery onto another vehicle or piece of machinery safely and easily. The fully sealed enclosure allows for a two stage handling of the transported vehicle. Currently, the transported vehicle can be handled multiple times during transport due to a change in the transport company or transport method (i.e. road to rail). The present invention allows the transported vehicle to safely remain within the Carpod no matter what modes of transport are employed. The unique roller door is lockable, allowing the client to open and shut the Carpod at the beginning and end of the journey. Thus, removing the possibility of the transported vehicle unnecessarily being in contact with people, animals, machinery or other cargo or the like during transport. Therefore, preserving the safety, protection and security of the vehicle.

The reference to any prior art in this specification is and should not be taken as, an acknowledgment or any form or suggestion that the prior art forms part of the common general knowledge.

Throughout the specification the aim has been to describe the invention without limiting the invention to any one embodiment or specific collection of features. Persons skilled in the relevant art may realize variations from the specific embodiments that will nonetheless fall within the scope of the invention.

We claim:

1. An apparatus for transporting vehicles, in the form of a self-contained pod module, comprising:
a structural base having a low angle ramp;
a structural front wall extending upwardly from a front end of the base having an inbuilt structural headboard frame;
a retractable enclosure attachable to the base and the headboard frame to form the roof and side walls for the pod, said retractable enclosure being supported by at least one structural metal rib; and
a lockable roller door provided at a rear end of the pod module and attachable to the enclosure to provide a fully sealed enclosure.

2. An apparatus for transporting vehicles of claim 1, wherein the retractable enclosure can be fully extended and locked to create a fully sealed unit around the transported vehicle.

3. An apparatus for transporting vehicles of claim 1, wherein the retractable enclosure is made of a flexible canvas material.

4. An apparatus for transporting vehicles of claim 1, wherein the retractable wall material is held in position by the least one structural metal rib which extends upwardly from the base and continuously along the retractable walls and is slidable along a sliding rail system provided on the base.

5. An apparatus for transporting vehicles of claim 1, wherein the structural rib(s) are mounted to carriers for sliding along a rail of the sliding rail system via at least one upright mounting plate.

6. An apparatus for transporting vehicles of claim 1, wherein at least one stop member, such as a rubber bump stop or the like, is provided at a rear end of the pod to stop the enclosure when sliding.

7. An apparatus for transporting vehicles of claim 1, wherein at least a pair of forklift points are provided on at least one side of the base of the apparatus, allowing the pod to be safely lifted and moved using a forklift or crane on and off a transport vehicle.

8. An apparatus for transporting vehicles of claim 1, wherein each corner point of the base has provided corner castings, allowing the pod to be connected to other pods or containers both horizontally and vertically, as well as being connected to various modes of transport such as ship, rail and road.

9. An apparatus for transporting vehicles of claim 1, wherein an anti-slip floor surface is provided on a front and a rear floor portions of the base.

10. An apparatus for transporting vehicles of claim 1, wherein at least one handle grip is provided at the rear end of the pod for pushing and pulling the retractable walls to open and close the enclosure.

11. An apparatus for transporting vehicles of claim 1, wherein a centre section and/or remainder of the headboard frame is adapted to receive at least one strap member.

12. An apparatus for transporting vehicles of claim 11, wherein the strap members, preferably aluminium straps, hold down and tension the retractable enclosure against the headboard frame.

13. An apparatus for transporting vehicles of claim 1, wherein a weather strip is provided on the base beneath the roller door to ensure a tight, weatherproof seal for the enclosure.

14. An apparatus for transporting vehicles of claim 1, wherein the roller door slides along the sliding rail system when the enclosure is retracted.

15. An apparatus for transporting vehicles of claim 1, wherein the roller door is attached to the rearmost structural metal rib via rails or a frame or the like using a hinge which enables the roller door to open outwardly, allowing additional space for the transported vehicle.

16. An apparatus for transporting vehicles of claim 1, wherein the headboard frame is designed to double as a toolbox or tyre rack, allowing for future toolboxes and/or storage units to be added.

17. An apparatus for transporting vehicles of claim 1, wherein the apparatus for transporting vehicles may further comprise internal toolboxes and/or tyre/wheel holders may be provided.

18. An apparatus for transporting vehicles of claim 1, wherein the apparatus further comprises at least one in-built remote access feature such as satellite tracking and/or live feed video camera for monitoring of the vehicle.

19. An apparatus for transporting vehicles of claim 18, wherein a multi-platform application enables a client to connect to their vehicle's pod module and remote access features via a mobile device such as a phone, tablet or computer or the like.

20. A method for transporting vehicles comprising the following steps:
opening a roller door of an apparatus of claim 1;
loading a vehicle to be transported into the apparatus; and
loading the apparatus containing the vehicle onto a mode of transport; and
wherein an enclosure of the apparatus can be retracted to allow the vehicle to be loaded/unloaded and allow an operator easy access to one or more sides of the transported vehicle at any time during transportation.
